(19) United States
(12) Patent Application Publication
(10) Pub. No.: US 2026/0125497 A1
(43) Pub. Date: May 7, 2026

(54) POLYMER, PREPARATION METHOD THEREFOR AND USE THEREOF

(71) Applicants: CHINA PETROLEUM & CHEMICAL CORPORATION, Beijing (CN); PETROLEUM EXPLORATION & PRODUCTION RESEARCH INSTITUTE, Beijing (CN)

(72) Inventors: Guangfu WANG, Beijing (CN); Haibo WANG, Beijing (CN); Xi LU, Beijing (CN); Jichao FANG, Beijing (CN); Liansheng WANG, Beijing (CN); Yong HU, Beijing (CN); Mengtao LI, Beijing (CN); Ping TANG, Beijing (CN)

(21) Appl. No.: 19/119,935

(22) PCT Filed: Oct. 10, 2023
(86) PCT No.: PCT/CN2023/123781

§ 371 Date: Apr. 10, 2025

(30) Foreign Application Priority Data
Oct. 11, 2022 (CN) 202211238976.3

(51) Int. Cl. C08F 20/58

(52) U.S. Cl. CPC C08F 20/58

(57) ABSTRACT

A polymer contains a sulfonate group, a benzene ring, and an unsaturated double bond at the same time. The molar ratio of the sulfonate group, the benzene ring, and the unsaturated double bond is 3-8:5-20:10-120. The number average molecular weight of the polymer is 1000-15000 g/mol. The polymer, as a viscosity reducer, has a high resistance to high concentrations of calcium and magnesium ions, a good viscosity reduction effect on super heavy oil, and good natural sedimentation and dehydration properties. It is resistant to viscosity rebound, has good water solubility, and has a simple matching injection process, and is suitable for practical use in oil fields.

### CROSS-REFERENCE TO RELATED APPLICATIONS

The application claims the benefit of the Chinese Patent Application No. “202211238976.3”, filed on Oct. 11, 2022, the content of which is specifically and entirely incorporated herein by reference.

### TECHNICAL FIELD

The present invention relates to the technical field of oil field development, in particular to a polymer, a preparation method therefor and a use thereof.

### BACKGROUND ART

The thick oil has the characteristics such as high viscosity, high density, poor fluidity, and temperature sensitivity, low content of light components, and high content of colloid and asphaltene. Research has shown that crude oils having a viscosity below 400 mPa·s can be extracted and transported. Therefore, a core problem during the extraction of thick oils is how to effectively reduce viscosity and improve the fluidity of the crude oil.

The existing extraction methods for thick oil include the thermal production process and the cold production process, wherein the thermal production process of thick oils requires high energy consumption and high costs; in contrast, the cold production process of thick oils does not need a heating process, it can reduce the viscosity of thick oil by means of the chemical viscosity reducer, an injection of CO₂, utilization of microorganisms coupled with the addition of physical fields, thus the extraction process has been widely applied in practice.

The representative technologies for reducing the viscosity of thick oil with the market application scale at present are as follows.

The wellbore visbreaking process for ultra-thick oil production: it uses a mixture of thin oil and a viscosity reducer for reducing viscosity. However, in light of the large price difference between the thin oil and the thick oil, the process does not allow for the oil recovery with cost-efficiency.

Emulsifying ultra-thick oil water-based viscosity reducer: the whole surface activity is greatly improved by taking advantage of the synergistic effect of the complex formulation of surfactants, it is possible to significantly reduce the oil-water interfacial tension, thereby achieving a viscosity reduction effect. However, the viscosity reducer in the method needs to mix with the thick oil for a long time under a high-speed stirring condition to produce the viscosity reduction effect, and the viscosity of the thick oil rebounds obviously after stopping the stirring process and standing still for a long time, thus it has poor effect in practical application.

The polyglycerol ester-based thick oil viscosity reducer: it can be used for thick oil with a viscosity between 2,000 mPa·s and 60,000 mPa·s at the temperature of 50° C., and produces the viscosity reduction effect by mixing and stirring at high speed. However, the viscosity reducer merely had a viscosity reduction ratio of 28%-75%, and the viscosity rebounds significantly after stopping the stirring process and standing still.

In addition, the currently used cold production viscosity reducers for thick oil impose the operating requirement on the concentration of calcium and magnesium ions in the formation water, their usable range suffers from a large limitation.

### SUMMARY OF THE INVENTION

The present disclosure aims to overcome the defects in the prior art that the thick oil has poor viscosity reduction effect under the reservoir condition of high concentration of calcium and magnesium ions, and the viscosity rebounds significantly after standing still, and discloses a polymer, a preparation method therefor and a use thereof, the polymer contains a sulfonate group, a benzene ring, and an unsaturated double bond at the same time, such that the polymer is not completely packed by the thick oil, and maintain the oil/water interface in an oil-in-water state, and the polymer has a low number average molecular weight, it can improve fluidity and reduce viscosity of the thick oil when added to the thick oil.

In order to achieve the above objects, the first aspect of the present invention discloses a polymer comprising a sulfonate group, a benzene ring, and an unsaturated double bond at the same time;
a molar ratio of the sulfonate group, the unsaturated double bond, and the benzene ring is (3-8):(5-20):(10-120);
a number average molecular weight of the polymer is within a range of 1,000-15,000 g/mol.

The second aspect of the present invention discloses a method for preparing the polymer comprising: subjecting monomer A and monomer B to an emulsion polymerization reaction in the presence of an initiator, a catalyst, and a surfactant under an anaerobic condition to obtain the polymer;
the monomer A contains a sulfonate group, and the monomer B contains a benzene ring and a unsaturated double bond;
wherein the molar ratio of the unsaturated double bond and the benzene ring in monomer B is 1:(1-3).

The third aspect of the present invention discloses the polymer produced with the method according to the second aspect.

The fourth aspect of the present invention discloses a method of using the polymer according to the first and third aspects as a viscosity reducer.

Due to the above technical schemes, the polymer, a preparation method therefor and a use thereof provided by the present disclosure generate the favorable effects as follows.
(1) The polymer provided by the present disclosure contains a sulfonate group, a benzene ring, and an unsaturated double bond at the same time and has a low number average molecular weight, the polymer has a desirable viscosity reduction effect on the super heavy oil having a viscosity within the range of 50,000-100,000 mPa·s, has high resistance to high concentrations of calcium and magnesium ions, excellent natural sedimentation and dehydration properties, can resist viscosity rebound, has good water solubility, is green and low-carbon, has a simple matching injection process, and is suitable for practical use in oil fields.
(2) The field application demonstrates that use of the polymer provided by the present disclosure can significantly improve the fluidity of the thick oil, and the viscosity reduction effect gradually decreases along with increased degassing viscosity of the thick oil, the viscosity reduction rate reaches 99% or more for the thick oil having a degassing viscosity of not more than 100,000 mPa·s; in addition, the viscosity reduction rate is substantially constant in the case that the concentrations of calcium and magnesium ions are less than 10,000 mg/L respectively, and the polymer has an excellent viscosity reduction effect when the concentrations of calcium and magnesium ions in the thick oil are not more than 30,000 mg/L; and the natural sedimentation dehydration rate can still reach 91% after the thick oil is standing still for 4 hours.

### BRIEF DESCRIPTION OF THE DRAWINGS

FIG. 1 illustrates a 300 MHz nuclear magnetic hydrogen spectrum of the polymer of Example 1 in the dimethyl sulfoxide (DOMSO) solvent;

FIG. 2 illustrates an infrared spectrogram of the polymer of Example 1.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

In the first aspect, the present invention discloses a polymer comprising a sulfonate group, a benzene ring, and an unsaturated double bond at the same time;
a molar ratio of the sulfonate group, the unsaturated double bond, and the benzene ring is (3-8):(5-20):(10-120);
a number average molecular weight of the polymer is within a range of 1,000-15,000 g/mol.

According to a particularly exemplary embodiment of the present disclosure, the molar ratio of the sulfonate group, the unsaturated double bond, and the benzene ring is (3-8):(5-20):(20-80).

In the present disclosure, a conjugated large π bond is formed between the benzene ring and the unsaturated double bond in the polymer, that is, a C atom is disposed between the benzene ring and the unsaturated double bond. The unsaturated double bond is a carbon-carbon double bond C═C.

The present inventors have discovered in researches that the benzene ring and the unsaturated C═C double bond structure in the polymer maintain a planar structure under the delocalization conjugation effect, it can be easily embedded into the asphaltene inter-layer structure in the thick oil, and weaken the π-π strong interaction; in addition, the strong electrical property of sulfonate group can attract water molecules by means of the coulombic force to form the nanometer water film, such that the polymer is not completely encapsulated by the thick oil, the oil/water interface in an oil-in-water state is maintained, the aggregation structure of colloid and asphaltene in the thick oil is dissociated, thus the polymer has a desirable resistant effect to viscosity rebound effect, and improves fluidity of the thick oil, the viscosity reduction of the thick oil can be achieved when the molecular weight of polymer falls into the aforementioned range, it is easier that the bound water releases from the oil phase after the degasing viscosity of the thick oil is reduced, the natural sedimentation dehydration rate of the thick oil can be improved.

Moreover, the sulfonate group in the polymer has extremely strong hydrophilicity, both the calcium sulfonate and the magnesium sulfonate generated from the contact of sulfonate group —SO₃⁻ with Ca²⁺ and Mg²⁺ are easily soluble in water, so the polymer is extremely resistant to calcium and magnesium ions.

In the present disclosure, the degassing viscosity refers to the viscosity measured after stirring the crude oil to remove free water and gas bubbles contained therein.

According to a particularly exemplary embodiment of the present disclosure, the molar ratio of the sulfonate group, the unsaturated double bond, and the benzene ring is (4-6):(6-12):(24-48).

According to a particularly exemplary embodiment of the present disclosure, the number average molecular weight of the polymer is within a range of 2,000-8,000 g/mol, optionally within a range of 2,100-5,800 g/mol.

In an exemplary embodiment of the present disclosure, the polymer has a molecular weight distribution within a range of 1.2-2, optionally within a range of 1.2-1.6.

According to an exemplary embodiment of the present disclosure, the polymer comprises structure unit A having a structure represented by formula I, and structure unit B having a structure represented by formula II:

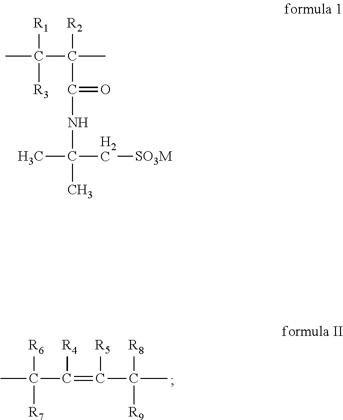

wherein R₁, R₂, R₃ in formula I are independently selected from hydrogen, substituted or unsubstituted C₁-C₆ alkyl, M is an alkali metal element, alkaline earth metal element, or NH₄⁺; R₄, R₅, R₆, R₇, R₈, R₉ in formula II are independently selected from hydrogen, substituted or unsubstituted C₁-C₆ alkyl, substituted or unsubstituted aryl, and at least two of R₄, R₅, R₆, R₇, R₈, R₉ are substituted or unsubstituted aryl.

In the present disclosure, the substituents in “substituted aryl” can be selected from the C₁-C₃ alkyl groups, and “unsubstituted aryl” refers to a benzene ring.

In a particularly exemplary embodiment of the present disclosure, wherein R₁, R₂, R₃ in formula I are independently selected from hydrogen, substituted or unsubstituted methyl, substituted or unsubstituted ethyl; R₆, R₇, R₈, R₉ in formula II are independently benzene ring, both R₄ and R₅ are independently selected from hydrogen, substituted or unsubstituted methyl, substituted or unsubstituted ethyl, that is, formula II may have a structure represented by formula (A):

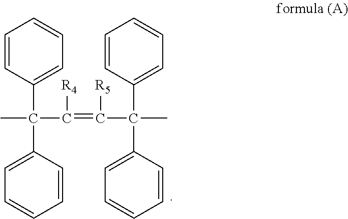

Optionally, R₁, R₂, and R₃ in formula I are independently hydrogen, M is Na, R₆, R₇, R₈, and R₉ in formula II are independently benzene ring, both R₄ and R₅ are independently hydrogen.

In an exemplary embodiment of the present disclosure, the structure unit A is contained in an amount within a range of 10-50 wt %, and the structure unit B is contained in an amount within a range of 50-90 wt %, based on the total weight of the polymer.

Optionally, the structure unit A is contained in an amount within the range of 16-50 wt %, and the structure unit B is contained in an amount within the range of 50-84 wt %, based on the total weight of the polymer.

The second aspect of the present invention discloses a method for preparing the polymer comprising: subjecting monomer A and monomer B to an emulsion polymerization reaction in the presence of an initiator, a catalyst, and a surfactant under an anaerobic condition to obtain the polymer;
the monomer A contains a sulfonate group, and the monomer B contains a benzene ring and a unsaturated double bond;
wherein a molar ratio of the unsaturated double bond and the benzene ring in monomer B is 1:(1-3).

In the present disclosure, the emulsion polymerization is performed by using monomer A containing sulfonate group and monomer B containing benzene ring and unsaturated double bond, the method is simple, when the obtained polymer is used for the viscosity reduction of thick oil, it has a desirable resistance to viscosity rebound, and improves the natural sedimentation dehydration rate of the thick oil.

In a particular embodiment of the present disclosure, when the content of the unreacted monomer in the post-reaction system is less than 0.1 wt %, the unreacted monomer is considered negligible. Therefore, it is considered in the disclosure that monomer A and monomer B are completely reacted.

In the present disclosure, the catalyst and the surfactant may be added at any stage before the implementation of the polymerization reaction.

According to an embodiment of the present disclosure, monomer A is used in an amount of 10-30 parts by weight, monomer B is used in an amount of 10-80 parts by weight, initiator is used in an amount of 2-10 parts by weight, catalyst is used in an amount of 1-5 parts by weight, and surfactant is used in an amount of 1-3 parts by weight.

In an exemplary embodiment of the present disclosure, monomer A is used in an amount of 15-25 parts by weight, monomer B is used in an amount of 20-50 parts by weight, initiator is used in an amount of 4-8 parts by weight, catalyst is used in an amount of 2-4 parts by weight, and surfactant is used in an amount of 2-3 parts by weight.

According to an embodiment of the present disclosure, the initiator comprises a water-soluble initiator and an oil-soluble initiator.

According to the present disclosure, the water-soluble initiator is at least one selected from the group consisting of 2,2′-azobis[2-methylpropionamidine]dihydrochloride, ammonium persulfate, potassium persulfate, sodium persulfate, and 2,2′-[azobis(1-methylethylidene)]bis[4,5-dihydro-1H-imidazole dihydrochloride, optionally 2,2′-azobis[2-methylpropionamidine]dihydrochloride.

According to the present disclosure, the oil-soluble initiator is at least one selected from the group consisting of dibenzoyl peroxide, tert-butyl peroxybenzoate, azobisisobutyronitrile, and di-tert-butyl peroxide, optionally dibenzoyl peroxide.

According to an embodiment of the present disclosure, the catalyst is at least one selected from the group consisting of tetramethylethylenediamine, dimethylethylenediamine, acetylacetone, cyclopentadiene, TiCl₄, TiCl₃, VOI₃, or VOCl₃, optionally tetramethylethylenediamine.

According to an embodiment of the present disclosure, the surfactant is at least one selected from the group consisting of Tween 20, Tween 40, Tween 60, polyethylene glycol 200, and peregal 0-20, optionally peregal O-20.

According to an embodiment of the present disclosure, a polymerization reaction conditions comprise a temperature within a range of 80-140° C. and a time of 1-8 h.

Optionally, the polymerization reaction conditions comprise a temperature within the range of 90-120° C. and a time of 1-5 h.

According to an embodiment of the present disclosure, the method further comprises subjecting the emulsion polymerization reaction to a quenching treatment.

In the present disclosure, the polymerization reaction is subjected to the inhibition and quenching treatment, such that the prepared polymer has a lower number average molecular weight to satisfy the requirement of viscosity reduction rate in the thick oil.

In an embodiment of the present disclosure, the quenching treatment is performed under the stirring condition.

Optionally, the stirring process has a rotational speed within the range of 1,000-2,200 rpm.

The present inventors have found when the rotational speed of the stirring process exceeds 2,200 rpm, it will cause that the oil-water interfaces to be excessively dispersed, the probability of individual monomer polymerization increases, the degree of interfacial blending and polymerization decreases, and the obtained product shows reduced activity for viscosity reduction. Therefore, the desirable results can be obtained by controlling the rotational speed of the stirring process to be within the above range.

Optionally, the stirring process has a rotational speed within the range of 1,200-1,900 rpm.

According to an embodiment of the present disclosure, the quenching treatment is performed at a temperature within a range of 0-15° C. for a time of 10-80 min.

According to an embodiment of the present disclosure, a quenching treatment is performed by adding a polymerization inhibitor.

According to an embodiment of the present disclosure, the polymerization inhibitor is at least one selected from the group consisting of hydroquinone, 2-sec-butyl-4,6-dinitrophenol, sodium sulphate, sodium sulphide, and ammonium thiocyanate, optionally hydroquinone.

According to an embodiment of the present disclosure, the polymerization inhibitor is used in an amount of 3-10 parts by weight, optionally 6-8 parts by weight, relative to 100 parts by weight of the monomer.

In an exemplary embodiment of the present disclosure, the method further comprises performing a concentration process to obtain the polymer after adding a polymerization inhibitor for performing the quenching treatment.

According to an embodiment of the present disclosure, the concentration process is performed at a temperature of 100-220° C. for a time of 1-10 hours.

The present inventors have found that if the concentration process is performed at a temperature below 100° C., it results in a too-long concentration time, and the subsequent industrial production cannot be implemented; if the concentration process is performed at a temperature above 220° C., the polymer has the risks of bond breakage and degradation. If the concentration process is performed for a time below 1 h, the concentrated amount of water is too small, provided that the concentration process is performed for a time above 10 h, the water may be evaporated and the product may be hardened. Therefore, better results are attainable while controlling the conditions of the concentration process to be within the above ranges.

Optionally, the concentration process is performed at a temperature of 150-180° C. for a time of 3-5 hours.

In the present disclosure, the catalyst and the solvent are removed within the aforementioned temperature range during the concentration process, moreover, the surfactant is decomposed, volatilized, or subjected to the bond breaking within the temperature range. The finally produced polymer lacks the existence of both the catalyst and the surfactant.

According to a particularly exemplary embodiment of the present disclosure, the method for preparing the polymer comprising:
(1) mixing the monomer A, a water-soluble initiator and a first solvent to obtain a first solution;
(2) blending the monomer B, an oil-soluble initiator, and a second solvent to obtain a second solution;
(3) subjecting the first solution and the second solution to a polymerization reaction in the presence of a catalyst and a surfactant under an anaerobic condition, then adding a polymerization inhibitor to perform the quenching treatment to prepare the polymer;
wherein the monomer A is a compound having a structure represented by formula III, and the monomer B is a compound having a structure represented by formula IV;

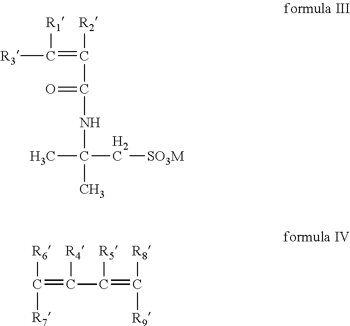

wherein R₁′, R₂′, R₃′ in formula III are independently selected from hydrogen, substituted or unsubstituted C₁-C₆ alkyl, M is an alkali metal element, alkaline earth metal element, or NH₄+; R₄′, R₅′, R₆′, R₇′, R₈′, R₉′ in formula IV are independently selected from hydrogen, substituted or unsubstituted C₁-C₆ alkyl, substituted or unsubstituted aryl, and at least two of R₄′, R₅′, R₆′, R₇′, R₈′, R₉′ are substituted or unsubstituted aryl.

In the present disclosure, the substituents in “substituted aryl” can be selected from the C₁-C₃ alkyl groups, and “unsubstituted aryl” refers to a benzene ring.

In a particularly exemplary embodiment of the present disclosure, R₆′, R₇′, R₈′, and R₉′ in formula IV are independently benzene rings, both R₄′ and R₅′ are independently selected from hydrogen, substituted or unsubstituted C₁-C₆ alkyl, substituted or unsubstituted aryl. That is, formula IV may have a structure represented by formula (B):

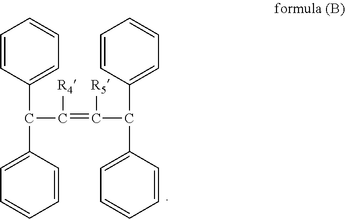

In an exemplary embodiment of the present disclosure, the first solvent is water.

In an exemplary embodiment of the present disclosure, the second solvent is at least one selected from the group consisting of toluene, xylene, and kerosene, optionally toluene.

In an exemplary embodiment of the present disclosure, the first solvent is used in an amount of 40-70 parts and the second solvent is used in an amount of 10-30 parts, relative to 100 parts by weight of the monomer.

In an exemplary embodiment of the present disclosure, R₁′, R₂′, and R₃′ in formula III are independently hydrogen, M is Na; both R₄′ and R₅′ in formula IV are hydrogen, under the circumstance, the monomer A is sodium 2-acrylamido-2-methylpropanesulfonate (AMPSNa), and the monomer B is 1,1,4, 4-tetraphenyl-1, 3-butadiene (1,1,4, 4-Tp-1, 3-Bd).

In an exemplary embodiment of the present disclosure, the method for preparing the polymer comprising:
(1) mixing sodium 2-acrylamido-2-methylpropanesulfonate (AMPSNa), 2,2′-azobis[2-methylpropionamidine]dihydrochloride (AIBA), tetramethylethylenediamine (TEMED), and water to obtain a first solution, wherein the sodium 2-acrylamido-2-methylpropanesulfonate (AMPSNa) is used in an amount of 10-25 parts by weight, the 2,2′-azobis[2-methylpropionamidine]dihydrochloride (AIBA) is used in an amount of 1-5 parts by weight, the tetramethylethylenediamine (TEMED) is used in an amount of 1-5 parts by weight, and water is used in an amount of 40-70 parts by weight;
(2) blending 1,1,4,4-tetraphenyl-1,3-butadiene (1,1,4,4-Tp-1,3-Bd), dibenzoyl peroxide (BPO), and toluene to obtain a second solution, wherein the 1,1,4,4-tetraphenyl-1,3-butadiene (1,1,4,4-Tp-1,3-Bd) is used in an amount of 10-60 parts by weight, the dibenzoyl peroxide (BPO) is used in an amount of 1-5 parts by weight, and the toluene is used in an amount of 10-30 parts by weight;
(3) mixing the first solution, the second solution, and the peregal 0-20 and stirring uniformly, removing oxygen gas by introducing nitrogen gas for 30-40 min, performing the polymerization reaction under an anaerobic condition, then adding hydroquinone, performing the quenching treatment under the stirring condition, and subsequently implementing the concentration process to prepare a polymer;
wherein the peregal 0-20 is used in an amount of 1-3 parts by weight, and the hydroquinone is used in an amount of 5-10 parts by weight;
the polymerization reaction conditions comprise a temperature of 90-120° C. and a time of 1-5 h; a rotation speed of the stirring process is within the range of 1,200-1,900 rpm; the quenching treatment is performed at a temperature of 0-10° C. for 10-40 min; and the concentration process is performed at a temperature of 150-180° C. for 1-10 h.

The third aspect of the present invention discloses the polymer produced with the method according to the second aspect.

The fourth aspect of the present invention discloses a method of using the polymer according to the first and third aspects as a viscosity reducer.

In the present disclosure, the polymer is applied to the thick oil as a viscosity reducer, wherein the method of using comprising: dissolving the polymer in deionized water to formulate a viscosity reducer sample solution having a concentration of 1-5 wt % and adding the solution to the thick oil for viscosity reduction, wherein a mass ratio of the viscosity reducer sample solution to the thick oil is within the range from 3:7 to 7:3.

According to the present disclosure, the polymer provided by the present disclosure is used as a viscosity reducer, the viscosity reduction rate of the thick oil having a degassing viscosity within the range of 50,000-100,000 mPa·s at 50° C. can reach 95% or more, optionally larger than or equal to 99%, and the sedimentation and dehydration rate is larger than or equal to 85% under the conditions consisting of a use concentration of 3-5 wt %, and the maximum concentration of calcium or magnesium ions in the thick oil is 30,000 mg/L, in addition, the polymer has excellent resistance to viscosity rebound, is green and low-carbon, and is suitable for practical use in oil fields.

The present invention will be described in detail with reference to examples. Unless otherwise specified in the invention, all the reagents used in the following examples are commercially available.

The contents of structure unit A and structure unit B in the polymer were measured through the nuclear magnetic carbon spectrum.

The content of sulfonate group in the polymer was measured and calculated by Elemental Analysis (EA), and the contents of benzene ring and unsaturated double bond were measured through the nuclear magnetic carbon spectrum.

The number average molecular weight and the molecular weight distribution of the polymer were determined by gel permeation chromatography (GPC).

The degassing viscosity of the thick oil was measured by the Brookfield DVIII rotational viscometer.

The concentrations of calcium and magnesium ions were measured by the titration method.

### Example 1

(1) 22 g of sodium 2-acrylamido-2-methylpropanesulfonate (AMPSNa), 2 g of 2,2′-azobis[2-methylpropionamidine]dihydrochloride (AIBA), 2 g of tetramethylethylenediamine (TEMED), and 60 g of water were mixed to obtain a first solution;
(2) 40 g of 1,1,4,4-tetraphenyl-1,3-butadiene (1,1,4,4-Tp-1,3-Bd), 4 g of dibenzoyl peroxide (BPO), and 20 g of toluene were blended to obtain a second solution;
(3) the first solution, the second solution, 2 g of peregal 0-20 were mixed and stirred uniformly, oxygen gas was removed by introducing nitrogen gas for 30 min, the polymerization reaction was performed under an anaerobic condition, 8 g of hydroquinone was then added, the quenching treatment was performed under the stirring condition, the concentration process was implemented to prepare a viscous and brown oily substance denoted as the polymer A1, the yield was 95.2%;
wherein the polymerization reaction conditions comprised a temperature of 95° C. and a time of 5 h, the rotational speed of the stirring process was 1,500 rpm, the quenching treatment was performed at a temperature of 0° C. and a time of 10 min, the concentration process was performed at a temperature of 180° C. for 3 h. The prepared polymer had a number average molecular weight of 5,242 g/mol and a molecular weight distribution of 1.3.

The polymer had the molar ratio of the sulfonate group, the unsaturated double bond, and the benzene ring of 5:6:24; the content of structure Unit A was 35.5 wt % and the content of structure Unit B was 64.5 wt %, based on the total weight of the polymer.

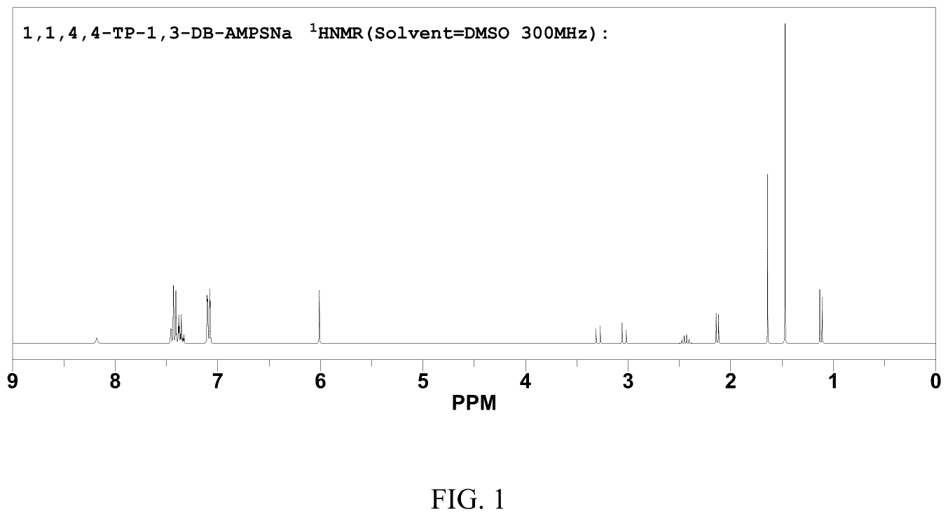

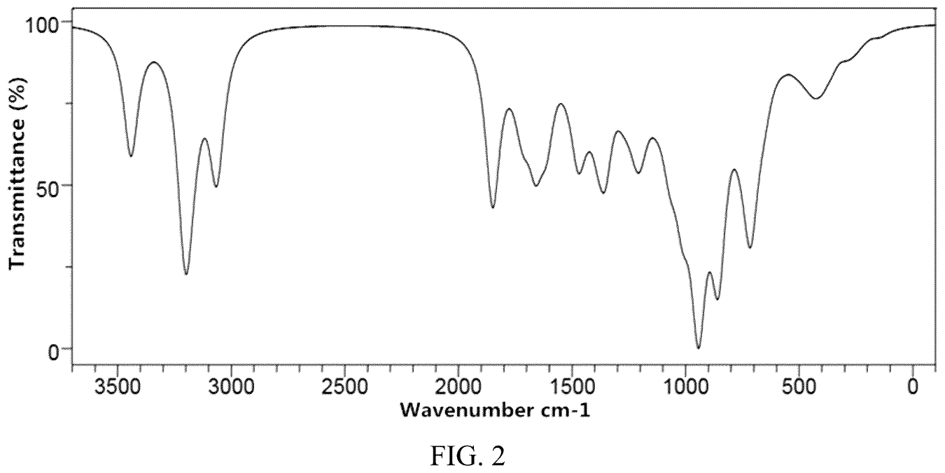

The polymer A1 was tested with the 300 MHz nuclear magnetic hydrogen spectrum in the DOMSO solvent as illustrated by FIG. 1, and an infrared spectrogram of the polymer A1 was illustrated in FIG. 2.

As can be seen from FIG. 1, the characteristic peak for H atoms in the benzene ring in 1,1,4,4-Tp-1,3-Bd monomer was located at displacement δ 7.09-7.43 ppm; the characteristic peaks for two H atoms in the group —C—CH═CH—C— were located at displacement δ 6.01 ppm; the characteristic peaks for three H atoms in the group —CH₂—CH— in the AMPSNa monomer were located at displacements δ 2.13 ppm and δ 1.12 ppm; it was analyzed on this basis, butadiene was polymerized with the carbon-carbon double bond C═C of AMPSNa monomer via the two terminal carbons, the backbone structure was —[C—CH═CH—C]—[CH₂—CH]−, and the characteristic peak for the group —NH in AMPSNa monomer was located at displacement δ 8.18 ppm, it indicated that the amide bonds were not hydrolyzed and maintained the long branched-chain structure during the polymerization process.

As illustrated by FIG. 2, the stretching vibration absorption peak of the carbon-carbon double bond C═C in the group C—C═C—C was located at the displacement 1763 cm⁻¹, the stretching vibration absorption peak of the group C—CH₂ after polymerization of —[C—CH═CH—C]−[CH₂—CH]— was located at the displacement 1011 cm⁻¹, it again indicated that the two monomers were polymerized with the carbon-carbon double bond C═C through the 1,4-carbon atoms, the stretching vibration absorption peak of the amide bond in the group CO—NH was located at the displacement 763 cm⁻¹, the stretching vibration absorption peak of the N—H bond in the group N—H was located at the displacement 3234 cm⁻¹, the absorption peaks were consistent with the characteristic peaks in the nuclear magnetic hydrogen spectrum, it indicated that the product had a long branched-chain structure.

FIG. 1 and FIG. 2 illustrated that the backbone structure of polymer A1 was —[C—CH═CH—C]—[CH₂—CH]—, and all the branched-chain structures of the monomers were retained.

### Example 2

(1) 15 g of sodium 2-acrylamido-2-methylpropanesulfonate (AMPSNa), 4 g of 2,2′-azobis[2-methylpropionamidine]dihydrochloride (AIBA), 2 g of tetramethylethylenediamine (TEMED), and 60 g of water were mixed to obtain a first solution;
(2) 44 g of 1,1,4,4-tetraphenyl-1,3-butadiene (1,1,4,4-Tp-1,3-Bd), 2 g of dibenzoyl peroxide (BPO), and 20 g of toluene were blended to obtain a second solution;
(3) the first solution, the second solution, 2 g of peregal 0-20 were mixed and stirred uniformly, oxygen gas was removed by introducing nitrogen gas for 30 min, the polymerization reaction was performed under an anaerobic condition, 8 g of hydroquinone was then added, the quenching treatment was performed under the stirring condition, the concentration process was implemented to prepare a viscous and brown oily substance denoted as the polymer A2, the yield was 95.6%;
wherein the polymerization reaction conditions comprised a temperature of 110° C. and a time of 2 h, the rotational speed of the stirring process was 1,800 rpm, the quenching treatment was performed at a temperature of 0° C. and a time of 40 min, the concentration process was performed at a temperature of 150° C. for 5 h. The prepared polymer had a number average molecular weight of 3,121 g/mol and a molecular weight distribution of 1.2.

The polymer had the molar ratio of the sulfonate group, the unsaturated double bond, and the benzene ring of 3:6:24; the content of structure Unit A was 25.4 wt % and the content of structure Unit B was 74.6 wt %, based on the total weight of the polymer.

### Example 3

(1) 22 g of sodium 2-acrylamido-2-methylpropanesulfonate (AMPSNa), 2 g of 2,2′-azobis[2-methylpropionamidine]dihydrochloride (AIBA), 2 g of tetramethylethylenediamine (TEMED), and 60 g of water were mixed to obtain a first solution;
(2) 22 g of 1,1,4,4-tetraphenyl-1,3-butadiene (1,1,4,4-Tp-1,3-Bd), 4 g of dibenzoyl peroxide (BPO), and 15 g of toluene were blended to obtain a second solution;
(3) the first solution, the second solution, 2 g of peregal 0-20 were mixed and stirred uniformly, oxygen gas was removed by introducing nitrogen gas for 30 min, the polymerization reaction was performed under an anaerobic condition, 6 g of hydroquinone was then added, the quenching treatment was performed under the stirring condition, the concentration process was implemented to prepare a viscous and brown oily substance denoted as the polymer A3, the yield was 97.8%;
wherein the polymerization reaction conditions comprised a temperature of 120° C. and a time of 1 h, the rotational speed of the stirring process was 1,800 rpm, the quenching treatment was performed at a temperature of 5° C. and a time of 40 min, the concentration process was performed at a temperature of 180° C. for 3 h. The prepared polymer had a number average molecular weight of 2,302 g/mol and a molecular weight distribution of 1.2.

The polymer had the molar ratio of the sulfonate group, the unsaturated double bond, and the benzene ring of 8:5:20; the content of structure Unit A was 50 wt % and the content of structure Unit B was 50 wt %, based on the total weight of the polymer.

### Example 4

The polymer was prepared according to the same method as that in Example 1, except that sodium 2-acrylamide-2-methylpropanesulfonate was replaced with potassium 2-acrylamide-2-methylpropanesulfonate, the polymer A4 was finally prepared, the number average molecular weight was 6,146 g/mol, the molecular weight distribution was 1.4.

### Example 5

The polymer was prepared according to the same method as that in Example 1, except that sodium 2-acrylamido-2-methylpropanesulfonate was used in an amount of 10 g, and 1,1,4,4-tetraphenyl-1,3-butadiene was used in an amount of 70 g, the polymer A5 was finally prepared, the number average molecular weight was 7,400 g/mol, the molecular weight distribution was 1.5.

The polymer had the molar ratio of the sulfonate group, the unsaturated double bond, and the benzene ring of 4:20:80; the content of structure Unit A was 12.5 wt % and the content of structure Unit B was 87.5 wt %, based on the total weight of the polymer.

### Example 6

The polymer was prepared according to the same method as that in Example 1, except that the quenching process in step (3) was performed at a temperature of 14° C. for 60 min. The polymer A6 was finally prepared, the number average molecular weight was 7,841 g/mol, and the molecular weight distribution was 1.6.

### Example 7

The polymer was prepared according to the same method as that in Example 1, except that hydroquinone was used in an amount of 3 g in step (3). The polymer A7 was finally prepared, the number average molecular weight was 7,863 g/mol, and the molecular weight distribution was 1.6.

### Example 8

The polymer was prepared according to the same method as that in Example 1, except that 1,1,4,4-tetraphenyl-1,3-butadiene is replaced with 1,1,4,4-tetraphenyl-2,3-dimethyl-1,3-butadiene, the polymer A8 was finally prepared, the number average molecular weight was 4,678 g/mol, the molecular weight distribution was 1.4.

### Example 9

The polymer was prepared according to the same method as that in Example 1, except that in the monomer A, R₁′, and R₂′ were independently methyl, R₃′ was ethyl, M was Na, the polymer A9 was finally prepared, the number average molecular weight was 5,320 g/mol, the molecular weight distribution was 1.5.

In the polymer, the molar ratio of the sulfonate group, the unsaturated double bond, and the benzene ring was 4:6:24.

### Example 10

The polymer was prepared according to the same method as that in Example 1, except that the polymerization reaction conditions comprised a temperature of 100° C. and a time of 1 h. The polymer A10 was prepared, the number average molecular weight was 6,721 g/mol, and the molecular weight distribution was 1.6.

### Example 11

The polymer was prepared according to the same method as that in Example 1, except that the polymerization reaction conditions comprised a temperature of 80° C. and a time of 30 min. The polymer A11 was prepared, the number average molecular weight was 1,126 g/mol, and the molecular weight distribution was 1.6.

### Example 12

The polymer was prepared according to the same method as that in Example 1, except that hydroquinone was used in an amount of 2 g, the polymer A12 was finally prepared, the number average molecular weight was 14,032 g/mol, and the molecular weight distribution was 1.5.

### Comparative Example 1

The polymerization was carried out according to the synthesis method of Example 1, except that the sodium 2-acrylamide-2-methylpropanesulfonate monomer of Example 1 was replaced with the acrylamide monomer represented by formula V, and the polymer D1 was prepared. The yield was 70.2%, and the obtained product had a number average molecular weight of 3,642 g/mol and a molecular weight distribution of 2.

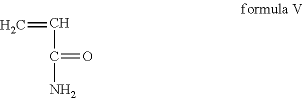

### Comparative Example 2

The polymerization was carried out according to the synthesis method of Example 1, except that the 1,1,4,4-tetraphenyl-1,3-butadiene monomer of Example 1 was replaced with the butadiene monomer represented by formula VI, the polymer D2 was prepared. The yield was 64.2%, and the obtained product had a number average molecular weight of 2,342 g/mol and a molecular weight distribution of 1.7.

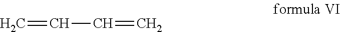

### Comparative Example 3

The preparation process was performed according to the same method as that in Example 1, except that 22 g of sodium 2-acrylamide-2-methylpropanesulfonate (AMPSNa) was replaced by an equivalent amount of 2-acrylamide-2-methylpropanesulfonic acid (AMPS), the solution was changed into micelle, the desired polymer cannot be produced.

### Test Example 1

The tests of viscosity reduction rate were conducted on the samples of thick oil having a degassing viscosity of 58120 mPa·s at 50° C. by using the polymers prepared in Examples and Comparative Examples as the viscosity reducers with different concentrations, wherein the testing method of viscosity reduction was as follows:
(1) 1-5 g of the polymers prepared in Examples and Comparative Examples were dissolved in 100 g of deionized water, and were respectively formulated into the viscosity reducer sample solutions having the concentration of 1-5 wt %;
(2) 280 g of thick oil sample (with the measured viscosity μ₀) was weighed and placed in a beaker, 120 g of the viscosity reducer sample solution formulated in step (1) was added, the beaker was placed in a water bath at the constant temperature of 50° C. for 1 h, a stirring paddle was disposed at the center of the beaker and 2-3 mm above the bottom, a rotational speed was adjusted as 250 r/min, the stirring was performed under the constant temperature condition for 2 min to obtain a thick oil emulsion;
(3) the viscosity of the thick oil emulsion was measured by using a rotational viscometer.

The viscosity reduction rate was calculated according to the formula f=(μ₀−μ)/μ₀×100%.

Wherein f denoted the viscosity reduction rate, μ₀ denoted the viscosity of the thick oil sample at 50° C., mPa·s, μ denoted the viscosity of the thick oil emulsion after adding the viscosity reducer sample solution, mPa·s.

The viscosity reduction results were shown in Table 1 and Table 1 (Continued).

TABLE 1

| Concentration | Viscosity reduction rate, % | | | | | | | |
|---|---|---|---|---|---|---|---|---|
| wt % | A1 | A2 | A3 | A4 | A5 | A6 | A7 | A8 |
| 1 | 97.3 | 97.3 | 96.6 | 94.7 | 95.3 | 94.8 | 84.6 | 85.6 |
| 2 | 98.1 | 97.7 | 97.3 | 95.3 | 95.8 | 95.5 | 85.1 | 86.1 |
| 3 | 98.2 | 98.1 | 98.1 | 95.7 | 96.6 | 96.3 | 85.4 | 86.4 |
| 4 | 99.2 | 99 | 98.9 | 96.8 | 97.8 | 97.7 | 86.1 | 87.3 |
| 5 | 99.5 | 99.1 | 99 | 97 | 98.1 | 97.9 | 86.2 | 87.5 |

| Concentration | Viscosity reduction rate, % | | | | | |
|---|---|---|---|---|---|---|
| wt % | A9 | A10 | A11 | A12 | D1 | D2 |
| 1 | 97.5 | 95.1 | 75.1 | 73.2 | 46.1 | 15.2 |
| 2 | 98.2 | 96.3 | 76.3 | 74.1 | 47.3 | 16.1 |
| 3 | 98.4 | 96.7 | 76.7 | 74.6 | 57.4 | 17.2 |
| 4 | 99.7 | 97.8 | 77.8 | 75.1 | 59.2 | 19.1 |
| 5 | 99.8 | 98 | 78 | 76.5 | 59.4 | 19.3 |

As can be seen from Table 1 and Table 1 (Continued), the viscosity reduction rate was raised along with an increased concentration of the viscosity reducer, the results of the polymer A1 were taken as an example, when the concentration of the viscosity reducer A1 increased from 4 wt % to 5 wt %, the increased amplitude of the viscosity reduction rate was only 0.3%, it was predictable that if the viscosity reducer concentration continued to increase, increase amplitude of the viscosity reduction rate would be unapparent, thus the maximum concentration of the viscosity reducer in use was optimized to 5 wt %. Under the maximum concentration condition of 5 wt %, the viscosity reduction rates were maintained above 99%.

Polymers D1 and D2 were not in compliance with the present disclosure, their viscosity reduction rates were less than 60% respectively. In addition, the polymers that do not fall into the specific molecular weight ranges required by the present disclosure cannot be desirably used for viscosity reduction.

### Test Example 2

The polymer A1 prepared in Example 1 with a concentration of 5 wt % was used as the viscosity reducer, the viscosity-reducing tests were conducted on the thick oil samples a, b, and c having degassing viscosity of 58,120 mPa·s, 76,800 mPa·s and 93,800 mPa·s at the temperature condition of 50° C., respectively, the viscosity reduction results were shown in Table 2.

TABLE 2

| | Degassing | | | Viscosity |
|---|---|---|---|---|
| Thick | viscosity/ | Viscosity | Concentration/ | reduction |
| oil | mPa · s | reducer | wt % | rate/% |
| a | 58120 | A1 | 5 | 99.5 |
| b | 76800 | A1 | 5 | 99.3 |
| c | 93800 | A1 | 5 | 99.1 |

As can be seen from Table 2, the viscosity reducer A1 with a concentration of 5 wt % had a gradually decreased viscosity reduction effect along with an increased degassing viscosity of the thick oil. The viscosity reduction rate was 99.5% when the degassing viscosity of the thick oil was within the range of 50,000-70,000 mPa·s; the viscosity reduction rate was 99.3% when the degassing viscosity of the thick oil was within the range of 70,000-90,000 mPa·s; the viscosity reduction rate was 99.1% when the degassing viscosity of the thick oil was within the range of 90,000-100,000 mPa·s. It was predictable that the viscosity reducer A1 with a concentration of 5 wt % had a limit viscosity reduction rate of less than 99% when the degassing viscosity of the thick oil exceeded 100,000 mPa·s. Therefore, the polymer of Example 1 as the viscosity reducer produced the desirable viscosity reduction effect for the raw oil having a degassing viscosity not exceeding 100,000 mPa·s.

### Test Example 3

Based on the viscosity reduction test results of Test Example 1, the viscosity reduction rates of the thick oil sample c under the different concentration conditions of calcium and magnesium ions were tested by using the polymer A1 with a concentration of 5 wt % as a viscosity reducer, the results were shown in Table 3.

TABLE 3

| Concentration of | Viscosity reduction | The reduced viscosity |
|---|---|---|
| calcium ions/mg/L | rate % | mPa · s |
| 0 | 99.3 | 656.6 |
| 1080 | 99.3 | 667.3 |
| 10000 | 99.3 | 691.6 |
| 20000 | 99.2 | 750.4 |
| 30000 | 99.1 | 844.2 |
| 35000 | 96.1 | 3641.6 |

| Concentration of | Viscosity reduction | The reduced viscosity |
|---|---|---|
| magnesium ions/mg/L | rate % | mPa · s |
| 0 | 99.3 | 657.3 |
| 1080 | 99.3 | 693.1 |
| 10000 | 99.2 | 752.1 |
| 20000 | 99.1 | 867.8 |
| 30000 | 98.9 | 997.3 |
| 35000 | 95.6 | 4120.2 |

As shown in Table 3 and Table 3 (Continued), the viscosity reduction rate of the viscosity reducer was kept constant when the concentration of calcium and magnesium ions in the thick oil was less than 10,000 mg/L; the viscosity reduction rate of the viscosity reducer was still kept constant when the concentration of calcium ions in the thick oil was not less than 10,000 mg/L; the viscosity reduction rate of the viscosity reducer was slightly decreased when the concentration of magnesium ions in the thick oil was not less than 10,000 mg/L. As can be seen, the polymer as a viscosity reducer had a stronger viscosity reduction effect on the thick oil having a high concentration of calcium ions. After the concentration of calcium ions in the thick oil exceeded 10,000 mg/L, the viscosity reduction rate of the viscosity reducer was gradually decreased along with an increase of the concentration; when the concentration of calcium ions in the thick oil reached 30,000 mg/L, the degassing viscosity of the thick oil after the viscosity reduction was 844.2 mPa·s, the thick oil still has a certain fluidity; when the concentration of calcium ions in the thick oil exceeded 30,000 mg/L, the degassing viscosity of the thick oil after the viscosity reduction was more than 1,000 mPa·s, because the high valence metal ions with a high concentration would generate a strong electrostatic attraction with the sulfonate group in the viscosity reducer, such that the viscosity reducer was concentrated at the oil/water interface, thereby reducing the embedding area of the conjugated aromatic hydrocarbon in the asphaltene, and impairing the viscosity reduction effect. Therefore, the polymer as a viscosity reducer according to the present disclosure had a desirable viscosity-reducing effect when the concentration of calcium and magnesium ions in the thick oil was not more than 30,000 mg/L.

### Test Example 4

The polymer A1 with a concentration of 5 wt % was used for testing the natural sedimentation dehydration rate and the viscosity reduction rate after 6 h of the thick oil c after the viscosity reduction under the condition of the concentration of calcium and magnesium ions of 30,000 mg/L in Test Example 3, respectively, the results were shown in Table 4.

TABLE 4

| | |
|---|---|
| Natural sedimentation | Viscosity reduction |
| dehydration rate (%) ^{a} | rate ^{b} (%) |

| Time | Calcium | Magnesium | Calcium | Magnesium |
|---|---|---|---|---|
| (h) | ions | ions | ions | ions |
| 1 | 88 | 81 | 98.3 | 97 |
| 2 | 90 | 88 | 97.7 | 96.5 |
| 3 | 91 | 90 | 97.3 | 96 |
| 4 | 92 | 91 | 97.1 | 95.8 |
| 5 | 92 | 91 | 96.7 | 95.8 |
| 6 | 92 | 91 | 96.7 | 95.8 |

^{a, b} The test was performed pursuant to the Enterprise Standard “Q/SLCG 0255-2018 Technical requirements of cold production throughput viscosity reducer for heavy oil” stipulated by the Shengli Oilfield Company.

As shown in Table 4, after standing still for 4 hours, the natural sedimentation dehydration rates of the thick oil c reached 92% and 91% respectively under the concentration condition of calcium and magnesium ions of 30,000 mg/L, and the rates were in a stable state, there was not the reverse emulsification phenomenon and the viscosity reduction rates were kept at 97.1% and 95.8% respectively, and the degassing viscosity of the thick oil c was maintained at about 4,000 mPa·s, and fluidity was significantly improved compared to the initial viscosity of 93,800 mPa·s.

Furthermore, Table 4 illustrated that the polymer A1 with a concentration of 5 wt % had a viscosity reduction rate of 95.8% after 6 h under the concentration condition of the magnesium ions of 30,000 mg/L, compared to the initial viscosity reduction rate of 99.1% under the concentration condition of the magnesium ions of 30,000 mg/L in Table 3 (Continued), the degassing viscosity rebound rate of crude oil was not larger than 3.3% (99.1%−95.8%=3.3%); as can be seen, the viscosity reduction property of the viscosity reducer has desirable stability. Therefore, the viscosity reducer provided by the present disclosure had satisfactory natural sedimentation dehydration rate and resistance to viscosity rebound, it did not affect the gathering transportation and emulsion breaking and can ensure the continuous effect after the viscosity reduction.

The above content describes in detail the exemplary embodiments of the invention, but the invention is not limited thereto. A variety of simple modifications can be made in regard to the technical solutions of the invention within the scope of the technical concept of the invention, including a combination of individual technical features in any other suitable manner, such simple modifications and combinations thereof shall also be regarded as the content disclosed by the invention, each of them falls into the protection scope of the invention.

1. A polymer, wherein the polymer contains a sulfonate group, a benzene ring, and an unsaturated double bond at the same time;
a molar ratio of the sulfonate group, the unsaturated double bond, and the benzene ring is (3-8):(5-20):(10-120);
a number average molecular weight of the polymer is within a range of 1,000-15,000 g/mol.

2. The polymer according to claim 1, wherein the number average molecular weight of the polymer is within a range of 2,000-8,000 g/mol; a molecular weight distribution is within a range of 1.2-2.

3. The polymer according to claim 1, wherein a conjugated large 71 bond is formed between the benzene ring and the unsaturated double bond in the polymer.

4. The polymer according to claim 1, wherein the polymer comprises structure unit A having a structure represented by formula I and structure unit B having a structure represented by formula II: 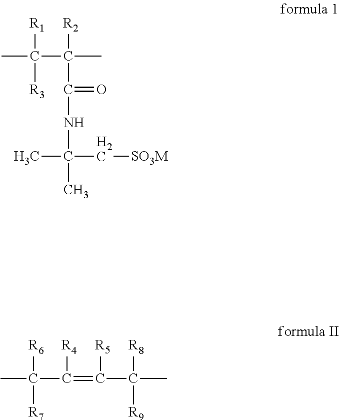
wherein R₁, R₂, R₃ in formula I are independently selected from hydrogen, substituted or unsubstituted C₁-C₆ alkyl, M is an alkali metal element, alkaline earth metal element, or NH₄⁺; R₄, R₅, R₆, R₇, R₈, R₉ in formula II are independently selected from hydrogen, substituted or unsubstituted C₁-C₆ alkyl, substituted or unsubstituted aryl, and at least two of R₄, R₅, R₆, R₇, R₈, R₉ are substituted or unsubstituted aryl.

5. The polymer according to claim 4, wherein R₁, R₂, R₃ in formula I are independently selected from hydrogen, substituted or unsubstituted methyl, substituted or unsubstituted ethyl; R₆, R₇, R₈, R₉ in formula II are independently benzene ring, both R₄ and R₅ are independently selected from hydrogen, substituted or unsubstituted methyl, substituted or unsubstituted ethyl.

6. The polymer according to claim 4, wherein the structure unit A is contained in an amount within a range of 10-50 wt %, and the structure unit B is contained in an amount within a range of 50-90 wt %, based on the total weight of the polymer.

7. A method for preparing the polymer comprising: subjecting monomer A and monomer B to an emulsion polymerization reaction in the presence of an initiator, a catalyst, and a surfactant under an anaerobic condition to obtain the polymer;
the monomer A contains a sulfonate group, and the monomer B contains a benzene ring and a unsaturated double bond;
wherein a molar ratio of the unsaturated double bond and the benzene ring in monomer B is 1:(1-3).

8. The method according to claim 7, wherein the monomer A is used in an amount of 10-30 parts by weight, the monomer B is used in an amount of 10-80 parts by weight, the initiator is used in an amount of 2-10 parts by weight, the catalyst is used in an amount of 1-5 parts by weight, and the surfactant is used in an amount of 1-3 parts by weight.

9. The method according to claim 7, wherein the monomer A is a compound having a structure represented by formula III, and the monomer B is a compound having a structure represented by formula IV; 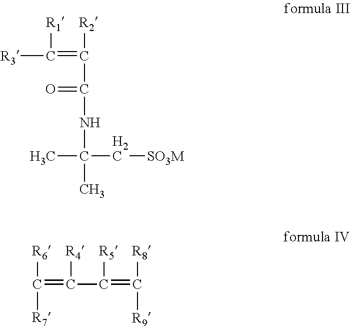
wherein R₁′, R₂′, R₃′ in formula III are independently selected from hydrogen, substituted or unsubstituted C₁-C₆ alkyl, M is an alkali metal element, alkaline earth metal element, or NH₄⁺; R₄′, R₅′, R₆′, R₇′, R₈′, R₉′ in formula IV are independently selected from hydrogen, substituted or unsubstituted C₁-C₆ alkyl, substituted or unsubstituted aryl, and at least two of R₄′, R₅′, R₆′, R₇′, R₈′, R₉′ are substituted or unsubstituted aryl.

10. The method according to claim 8, wherein the initiator comprises a water-soluble initiator and an oil-soluble initiator.

11. The method according to claim 7, wherein the catalyst is at least one selected from the group consisting of tetramethylethylenediamine, dimethylethylenediamine, acetylacetone, cyclopentadiene, TiCl₄, TiCl₃, VOI₃, or VOCl₃.

12. The method according to claim 7, wherein the surfactant is at least one selected from the group consisting of Tween 20, Tween 40, Tween 60, polyethylene glycol 200 and peregal O-20.

13. The method according to claim 7, wherein emulsion polymerization reaction conditions comprise a temperature within a range of 80-140° C. and a time of 1-8 h.

14. The method according to claim 7, wherein the method further comprises subjecting the emulsion polymerization reaction to a quenching treatment.

15. The method according to claim 14, wherein the quenching treatment is performed by adding a polymerization inhibitor.

16. (canceled)

17. A method of using the polymer according to claim 1 as a viscosity reducer.

18. The polymer according to claim 4, wherein R₆, R₇, R₈, and R₉ in formula II are independently benzene rings, both R₄ and R₅ are independently selected from hydrogen, substituted or unsubstituted C₁-C₆ alkyl, substituted or unsubstituted aryl.

19. The polymer according to claim 6, wherein the structure unit Ais contained in an amount within a range of 16-50 wt %, and the structure unit B is contained in an amount within a range of 50-84 wt %, based on the total weight of the polymer.

20. The method according to claim 10, wherein the water-soluble initiator is at least one selected from the group consisting of 2,2′-azobis[2-methylpropionamidine]dihydrochloride, ammonium persulfate, potassium persulfate, sodium persulfate, and 2,2′-[azobis(1-methylethylidene)]bis[4,5-dihydro-1H-imidazole dihydrochloride;
and/or, the oil-soluble initiator is at least one selected from the group consisting of dibenzoyl peroxide, tert-butyl peroxybenzoate, azobisisobutyronitrile, and di-tert-butyl peroxide.

21. The method according to claim 14, the quenching treatment is performed at a temperature within a range of 0-15° C. for a time of 10-80 min.
